(19) United States
(12) Patent Application Publication
(10) Pub. No.: US 2007/0203806 A1
(43) Pub. Date: Aug. 30, 2007

(54) Book publishing systems and methods

(76) Inventors: David Caney, Oceanside, CA (US); Tom Carpenter, Aliso Viejo, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/527,058

(22) Filed: Sep. 25, 2006

Related U.S. Application Data
(60) Provisional application No. 60/721,850, filed on Sep. 28, 2005.

(51) Int. Cl. G07F 7/00; G06F 17/30

(52) U.S. Cl. 705/27; 705/26

(57) ABSTRACT

A system and a method is provided wherein a web site may provide templates for producing high quality brochures, fliers, book, magazines, periodicals and the like where the consumer may select from the templates in a plurality of different fields, including real estate, law, education, medicine, dentistry and the like. Additionally the present invention provides a system and method for uploading capabilities for including text, images and other documents into the templates. Moreover, the present invention provides a system and method for providing completed documents that may be available for download by local franchisees or company stores for printing and on-site binding, including preferably perfect binding.

### PRIORITY DATA

This application claims priority to an earlier filed U.S. Provisional Patent, Ser. No. 60/721850 filed on Sep. 28, 2005.

### FIELD OF THE INVENTION

The field of the invention is book publishing. More specifically, the present invention relates to online book publishing and systems and methods for the same.

### BACKGROUND

With the proliferation of electronic mediums for entertainment purposes, many of the traditional tangible medium entertainment ideas have needed to be transformed from a fixed medium to an electronic medium. For example, books, magazines and the like are now not only offered in paper form, but may be downloaded onto the internet and viewed by a remote user without ever print or picking up a paper copy of the same. Additionally, the desire to have books, magazines and the like in paper form may be desirable at a remote location, and allowing these books, magazines, periodicals and the like to be downloaded from the internet and printed at the user's desire has proven advantageous and may also cut the cost of production and manufacture for the publisher.

Kinkos™ and other photocopying and printing companies have been offering their services over the Internet for many years. Using such services a customer can readily upload a file to a website, provide instructions for printing and binding, and even order delivery of the documents by FedEx, mail or some other method. These services are available for a wide range of document formats, (including for example business cards, fliers, legal briefs, manuscripts, and even large posters), black and white and color processes, and bindings.

There are numerous website sites that allow customers to build their documents from templates. For example, the site at www.LateNightPrinters.com allows customers to build custom business cards using templates in the fields of animals, beauty & fashion, business & finance, computers & technology, economy/best value, entertainment, food & beverage, health & medicine, law & order, locations & cities, music & art, nature, objects, organizations & groups, people/social, real estate, religious, simple patterns, sports, trades & construction, and transportation.

Other sites provide templates for brochures and fliers, (see e.g. http://www.hp.com/sbso/productivity/office/brochure.html, and http://www.stocklayouts.com/AboutDesigns.aspx). Still other sites (e.g. www.koolprint.com) offer customers the opportunity to upload manuscripts, and have them printed and bound on demand, in double digit and even single digit quantities.

One significant problem has been the binding. Many print shops have in-house capability to volo-bind and perform other simple binding, but many outsource their perfect binding. Since at least 1995 Xerox has been marketing their DocuTech™ equipment, which could do both perfect binding and saddle stitching. Such systems, however, are reported to have been disfavored by the printing community because their price tags of $250,000 to $300,000 do not justify producing only one or two bound books a minute.

More recently, low-cost off-line binding systems have become available. Such systems can print and bind several hundred copies an hour. However, not all perfect binding systems are of the same quality. The better systems mill the spine sufficiently to expose enough of the edge fibers to assure good adhesion on all kinds of papers. Top of the line perfect binders have a side-gluing device that applies adhesive not only to the spine, but also along the sides. The best machines also score the covers.

However, a problem exists in that all the known web sites that offer print on demand are inadequate in that they require substantial personnel interaction on the part of the printing company to ready the documents for printing.

Additionally, another problem exists in that the printing company must utilize use off-site binders for high-quality perfect binding, a process that add several days or more to the turn-around time.

### SUMMARY OF THE INVENTION

The present invention provides a system and a method wherein a web site may provide templates for producing high quality brochures, fliers, book, magazines, periodicals and the like where the consumer may select from the templates in a plurality of different fields, including real estate, law, education, medicine, dentistry and the like. Additionally the present invention provides a system and method for uploading capabilities for including text, images and other documents into the templates. Moreover, the present invention provides a system and method for providing completed documents that may be available for download by local franchisees or company stores for printing and on-site binding, including preferably perfect binding.

To this end in an exemplary embodiment of the present invention a method for preparing bound paper publications, comprising the steps of: providing templates with which users can collect and organize printable information to form printable images, including at least one cover image; and a second party providing at least one electronically accessible site that users can employ to build or upload their images, and from which third parties can download the images to print and bind the publications.

In an exemplary embodiment the method further comprises the step of: allowing a user to upload and download information at separate websites.

In an exemplary embodiment the method further comprises the step of: allowing user access to the website wherein the user utilizes a password to access the sites.

In an exemplary embodiment the method further comprises the step of: providing templates for different industries including real estate, law, education, medicine, dentistry among others.

In an exemplary embodiment the method further comprises the step of: allowing access by a user wherein the user may access third party providers and the third party providers uses the information downloaded from the user to provide bound paper publications.

In an exemplary embodiment of the present invention, a web-based business is provided. The web based business may have a plurality of templates that are provided to user members of the public to assist in preparing cover designs for printed publications. Additionally, the web-based business may have a portal through which the users can build and/or upload their cover designs, and from which third parties can download the cover designs, to print and bind said printed publications.

In an exemplary embodiment, the web-based business may utilize a plurality of templates including different industries like real estate, law, education, medicine, dentistry among others.

In an exemplary embodiment, the web-based business may utilize business charges for allowing a user to build and/or download information and for third party download of the information built or uploaded by the individual user.

In an exemplary embodiment, the systems and methods in which the perfect binding provides proper spine milling and side-gluing of the pages.

The attached figures include exemplary images of numerous pages from the ExactBind West website, showing various templates. Also included are exemplary images of completed books, booklets (both hardbound and softbound) that are produced according to the methods described herein.

One significant difference over the known prior art is that preferred methods herein contemplate that the web site(s) may provide(s) an upload functionality accessible by many different customers, and a download functionality accessible by many different printers. Under this new paradigm, for example, a hundred or more printers could cooperate within a company or organization, each independently accessing print jobs according to their individual availability. It is also contemplated that such individual printers could privately (and preferably automatically) compete with each other for jobs.

An advantage of the present invention in an exemplary embodiment is to provide a system and method for perfect bind presentations of books on demand.

Yet another advantage of the present invention in an exemplary embodiment is to provide a unskilled operator the ability to perfect bind presentations and/or books on demand.

Another advantage of the present invention in an exemplary embodiment is to provide an operator the ability to print presentation/book content, prepare a cover and bind the presentation and/or book at the operator's desire.

Still another advantage of the present invention in an exemplary embodiment is to provide an operator the ability to make perfectly square binds, without unnecessary waste of paper.

Yet another advantage of the present invention in an exemplary embodiment is the system and method for downloading, printing and binding any number of presentations and or books on demand. The system may be able to print and bind hundreds of quality books/presentations each day.

Another advantage of the present invention in an exemplary embodiment is the system and method that allows for a plurality of print and presentation formats including as small as three inches and as large as twenty inches.

Still another advantage of the present invention in an exemplary embodiment is a system and method for on-demand bind and publishing systems wherein the system may bind very small presentations and/or large books giving each on-demand bind a quality, heavy duty look.

Yet another advantage of the present invention in an exemplary embodiment is a system and method whereby the system may allow for download, printing and binding of soft covered books, hard-covered books, presentations and the like.

Another advantage of the present invention in an exemplary embodiment is a system and method for publishing and printing wherein print shop fulfillment centers may be qualified and provided with web-based ordering system and binding equipment to enable the publishing of hard cover books on demand.

Such a system is quite different from that of Kinkos™ and others, where print jobs are sent to specific locales, and where one printer may be overwhelmed with projects while another printer has excess capacity.

These and other objects of the invention will become more clear when one reads the following specification, taken together with the drawings that are coupled hereto. The scope of protection sought by the inventors may be gleaned from a fair reading of the Claims that conclude this specification.

Additional features and advantages of the present invention are described in, and will be apparent from, the detailed description of the presently preferred embodiments and from the drawings.

### BRIEF DESCRIPTION OF THE DRAWING AND ATTACHMENTS

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

FIG. 1 illustrates a screen shot of the online system in an exemplary embodiment of the present invention;

FIG. 2 illustrates another screen shot of the online system in an exemplary embodiment of the present invention;

FIG. 3 illustrates yet another screen shot of the online system comprising a book in an exemplary embodiment of the present invention;

FIG. 4 illustrates a screen shot of an real estate illustration in an exemplary embodiment of the present invention;

FIG. 5 illustrates another screen shot of an real estate illustration in an exemplary embodiment of the present invention;

FIG. 6 illustrates a screen shot of an real estate illustration in an exemplary embodiment of the present invention;

FIG. 7 illustrates a screen shot of an real estate illustration in an exemplary embodiment of the present invention; and

FIG. 8 illustrates a screen shot of an real estate illustration in an exemplary embodiment of the present invention.

### DETAILED DESCRIPTION OF THE PREFERRED EMBODIMENT

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

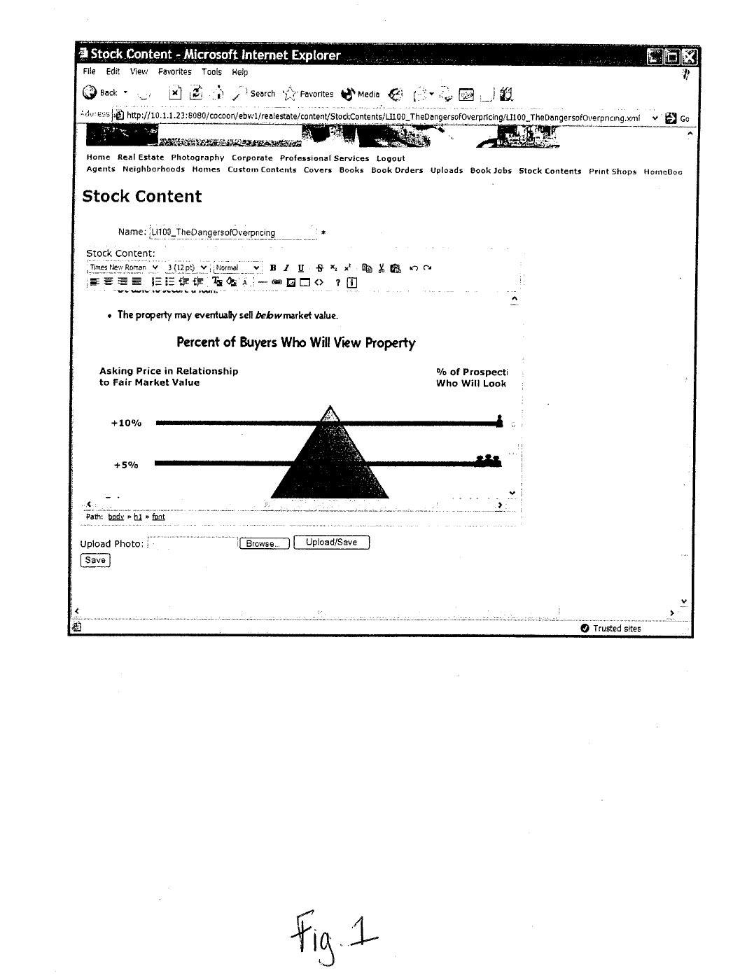

As illustrated in FIG. 1, the present invention illustrates a system and method for utilizing a web-based application to upload and/or build presentations, books, periodicals, and other printed publications with relative ease. The system and method utilizes a program wherein a user may upload and/or build a printed publication online without needing the printed copy in order to finish the publication. Additionally, the system and method utilize a third party to download, print and bind the printed publication for the user.

As illustrated in FIG. 1, a screen shot is illustrated showing the process used by the user wherein the user may upload information to the system. The user may utilize a standard web browsing application such as netscape, or internet explorer. The screen may prompt the user to browse their own computer or attached device for the information that they wish to upload from their computer/ attached device to the website. Additionally, the website may allow a user to build and/or compose a printed publication directly onto the website without needing to upload any information from the user's computer and/or attached device.

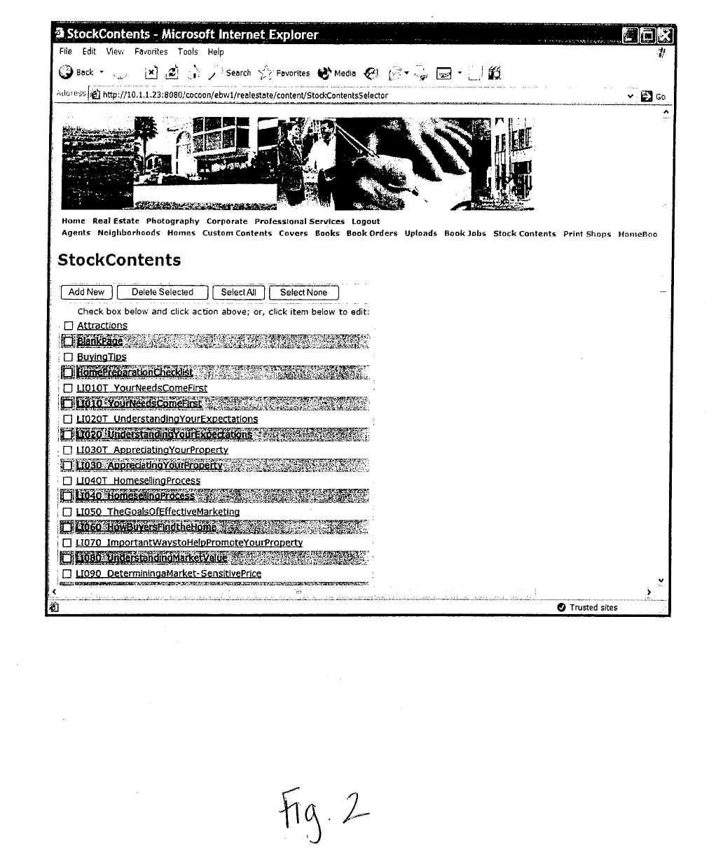

FIG. 2 illustrates the uploading of multiple images, text and other information that may be included in the total upload and/or building process. The system allows a user to add new information, deleted information from the upload, select only certain information for upload and/or allows the user to select none of the information for edit, upload or building of a printed publication.

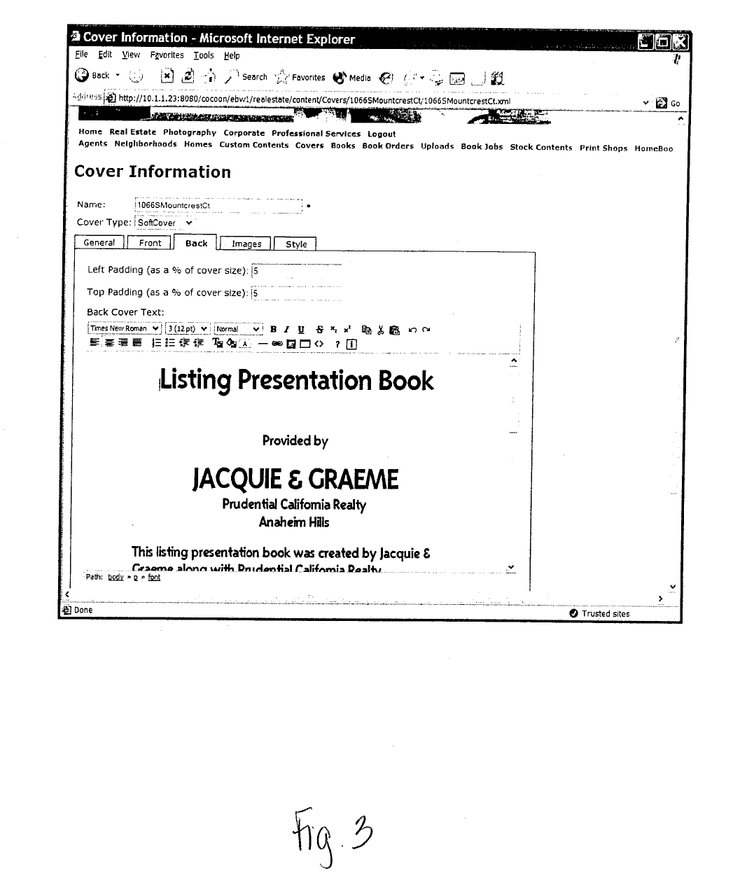

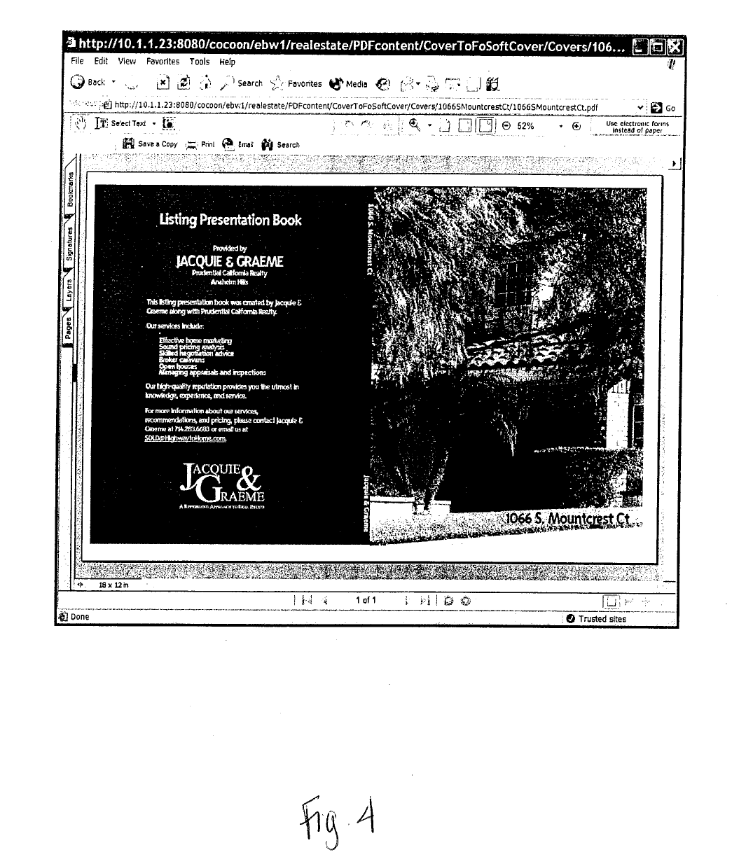

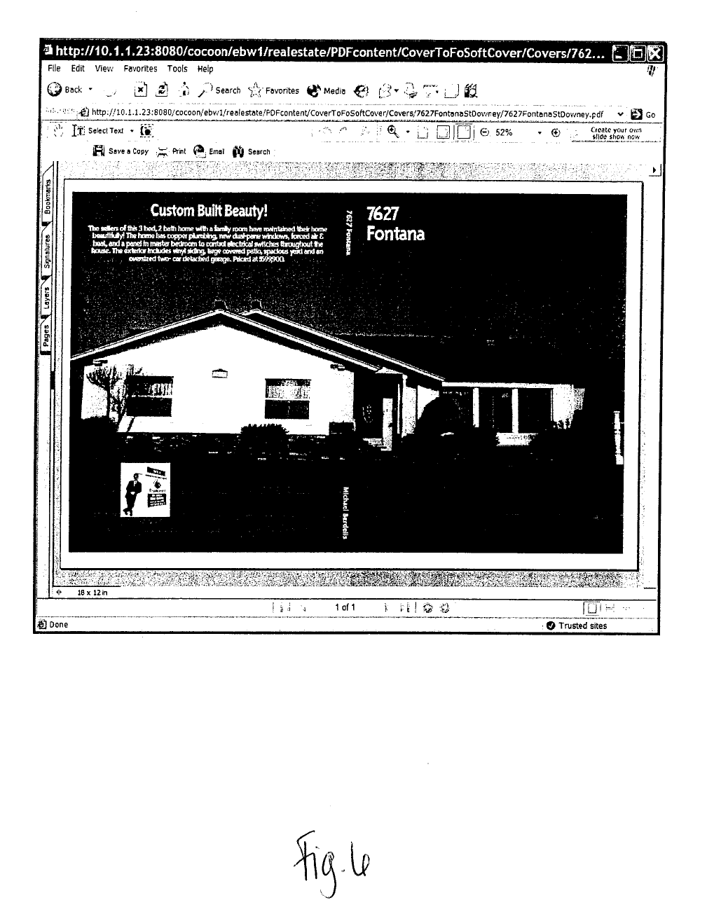

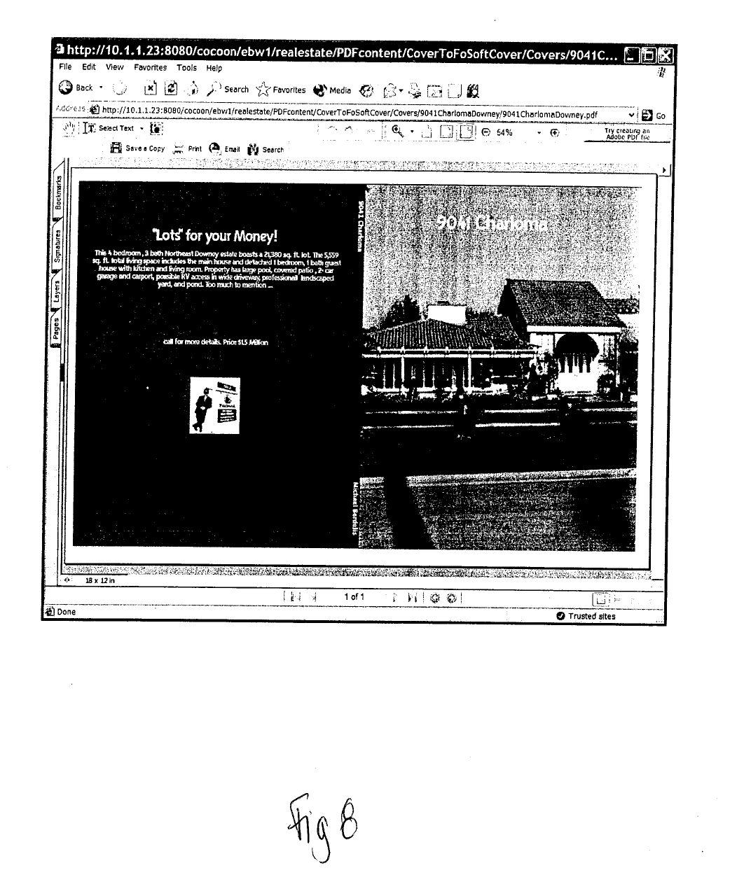

FIG. 3 illustrates a screen shot of the web-based application wherein the uploaded information is shown to the user and allows the user to edit the information uploaded and/or created within the web-based application. The user may alter the margins, fonts, images, styles, sizes, content along with a plurality of different information desired by the individual user. The user can allocate a name and type of cover to be included in the printed publication and the type of binding they wish to have in associated with the publication. FIGS. 4, 6 and 8 illustrate the coverings that may be utilized by a user that will be used for the front and back covers of the printed publication.

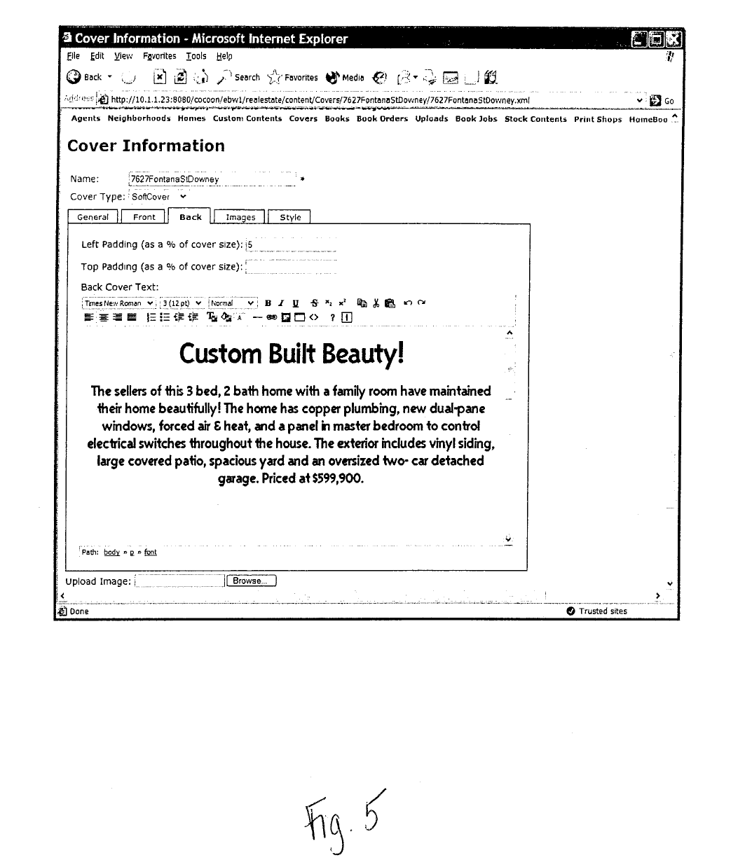

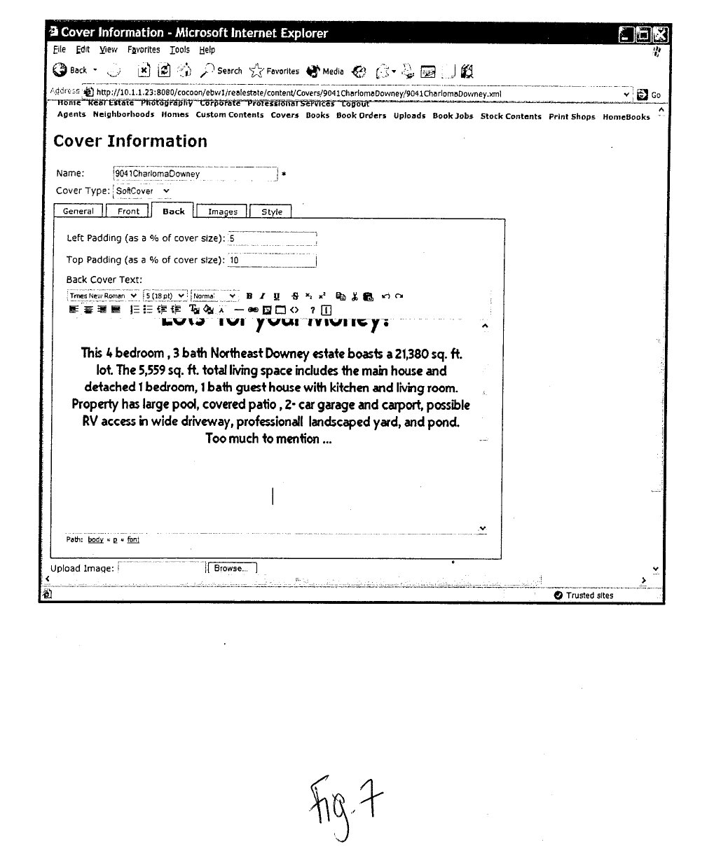

FIGS. 5, 7 and illustrated a screen shot of the web based application wherein the user may be able to customize the back portion of the cover of the printed publication to illustrate the information, images and binding desired in that publication.

Thus, specific embodiments and applications of accommodative intraocular lens have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

The following claims are provided to add additional clarity to this disclosure. Future applications claiming priority to this application may or may not include the following claims, and may include claims broader, narrower, or entirely different from the following claims

1. A method for preparing bound paper publications, comprising the steps of:
providing templates with which users can collect and organize printable information to form printable images, including at least one cover image; and
a second party providing at least one electronically accessible site that users can employ to build or upload their images, and from which third parties can download the images to print and bind the publications.

2. The method of claim 1 further comprising the step of:
allowing a user to upload and download information at separate websites.

3. The method of claim 1 further comprising the step of:
allowing user access to the website wherein the user utilizes a password to access the sites.

4. The method of claim 1 further comprising the step of:
providing templates for different industries including real estate, law, education, medicine, dentistry among others.

5. The method of claim 1 further comprising the step of:
allowing access by a user wherein the user may access third party providers and the third party providers uses the information downloaded from the user to provide bound paper publications.

6. A web-based business comprising:
a plurality of templates that are provided to user members of the public to assist in preparing cover designs for printed publications; and
a portal through which the users can build and/or upload their cover designs, and from which third parties can download the cover designs, to print and bind said printed publications.

7. The web-based business further comprising:
the plurality of templates including different industries like real estate, law, education, medicine, dentistry among others.

8. The web-based business further comprising:
the business utilizing business charges for allowing a user to build and/or download information and for third party download of the information built or uploaded by the individual user.
